(19) United States
(12) Patent Application Publication
(10) Pub. No.: US 2026/0046738 A1
(43) Pub. Date: Feb. 12, 2026

(54) Switching Between Non-Terrestrial Network and Terrestrial Network

(71) Applicant: Apple Inc., Cupertino, CA (US)

(72) Inventors: Fangli XU, Beijing (CN); Yuqin CHEN, Beijing (CN); Haijing HU, Los Gatos, CA (US)

(21) Appl. No.: 19/102,227

(22) PCT Filed: Aug. 9, 2022
(86) PCT No.: PCT/CN2022/111247

§ 371 Date: Feb. 7, 2025

(51) Int. Cl. H04W 36/36; H04W 76/19; H04W 84/06

(52) U.S. Cl. CPC H04W 36/362; H04W 76/19; H04W 84/06

(57) ABSTRACT

Example embodiments of the present disclosure relate to a UE and a BS for a solution of switching between a non-terrestrial network and a terrestrial network. A UE determines whether a service based handover condition is met; and switches from a first cell to a second cell if the service based handover condition is met, where the first cell is one of an NTN cell and a TN cell, the second cell is the other of the NTN cell and the TN cell. As such, a service requirement may be considered while switching, and thus the service at the UE may be guaranteed.

### TECHNICAL FIELD

Embodiments of the present disclosure generally relate to the field of telecommunication and in particular, to a user equipment (UE) and a base station (BS) for a solution of switching between a non-terrestrial network (NTN) and a terrestrial network (TN).

### BACKGROUND

A non-terrestrial network (NTN) refers to a network or a segment of network which uses an airborne or a space borne vehicle for transmission. The NTN may provide an NTN cell which covers a wider range than a terrestrial network (TN) cell provided by a TN. When a UE is located within a serving cell, it may execute a handover (HO) to a candidate cell if, for example, a conditional handover (CHO) condition is met. In some events, the CHO condition may be set based on a measurement event. However, the CHO condition does not consider NTN/TN characteristics and thus needs to be improved and optimized.

### SUMMARY

In general, example embodiments of the present disclosure provide a solution for switching between an NTN and a TN.

In a first aspect, there is provided a baseband processor of a UE configured to perform operations comprising: determining whether a service based handover condition is met; and in accordance with a determination that the service based handover condition is met, switching from a first cell to a second cell, the first cell being one of an NTN cell and a TN cell, the second cell being the other of the NTN cell and the TN cell.

In a second aspect, there is provided a baseband processor of a BS configured to perform operations comprising: determining, for a UE, a service based handover condition under which the UE is to switch from a first cell to a second cell, the first cell being one of an NTN cell and a TN cell, the second cell being the other of the NTN cell and the TN cell; and transmitting, using a transceiver and to the UE, information indicating the service based handover condition.

In a third aspect, there is provided a UE. The UE comprises: a transceiver configured to communicate with a network; and a processor communicatively coupled to the transceiver and configured to perform operations comprising: determining whether a service based handover condition is met; and in accordance with a determination that the service based handover condition is met, switching from a first cell to a second cell, the first cell being one of an NTN cell and a TN cell, the second cell being the other of the NTN cell and the TN cell.

In a fourth aspect, there is provided a BS. The BS comprises: a transceiver configured to communicate with a network; and a processor communicatively coupled to the transceiver and configured to perform operations comprising: determining, for a user equipment (UE), a service based handover condition under which the UE is to switch from a first cell to a second cell, the first cell being one of an NTN cell and a TN cell, the second cell being the other of the NTN cell and the TN cell; and transmitting, using the transceiver and to the UE, information indicating the service based handover condition.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Through the more detailed description of some embodiments of the present disclosure in the accompanying drawings, the above and other objects, features and advantages of the present disclosure will become more apparent, wherein:

FIG. 1A illustrates an example network environment in which some example embodiments of the present disclosure may be implemented;

FIG. 1B illustrates another example network environment in which some example embodiments of the present disclosure may be implemented;

FIG. 2 illustrates an example of a process flow in accordance with some example embodiments of the present disclosure;

FIG. 3 illustrates an example of a process flow for the BS configuring the service based handover condition associated with one cell in accordance with some example embodiments of the present disclosure;

FIG. 4 illustrates an example of a process flow for the BS configuring the service based handover condition associated with multiple cells in accordance with some example embodiments of the present disclosure;

FIG. 5 illustrates an example of a process flow for UE preference in accordance with some example embodiments of the present disclosure;

FIG. 6 illustrates an example of a process flow for UE decision in accordance with some example embodiments of the present disclosure;

FIG. 7 illustrates a flowchart of a method implemented at a UE in accordance with some example embodiments of the present disclosure;

FIG. 8 illustrates a flowchart of a method implemented at a BS in accordance with some example embodiments of the present disclosure; and

FIG. 9 illustrates a simplified block diagram of a device that is suitable for implementing some example embodiments of the present disclosure.

Throughout the drawings, the same or similar reference numerals represent the same or similar elements.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

The terminology used herein is for the purpose of describing particular embodiments only and is not intended to be limiting of example embodiments. For example, as used herein, the singular forms “a”, “an” and “the” are intended to include the plural forms as well, unless the context clearly indicates otherwise. The terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof. Moreover, when a particular feature, structure, or characteristic is described in connection with some embodiments, it is submitted that it is within the knowledge of one skilled in the art to affect such feature, structure, or characteristic in connection with other embodiments whether or not explicitly described.

It is also to be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

As mentioned above, an NTN may use an airborne vehicle or a space borne vehicle for transmission. The airborne vehicle may include a satellite, such as a low earth orbit (LEO) satellite, a medium earth orbit (MEO) satellite, a geosynchronous orbit (GEO) satellite, a highly eccentric orbit (HEO) satellite or another type of satellite. In some specific cases, the satellite may also, or alternatively pertain to one or more satellite systems or architectures, such as a global navigation satellite system (GNSS), global positioning system (GPS), global navigation satellite system (GLONASS), BeiDou navigation satellite system (BDS), etc. The space borne vehicle may include high altitude platforms (HAPS).

The NTN may be used in multiple different scenarios, such as maritime, airplane connectivity or railway, so as to address mobile broadband needs and public safety needs in unserved or underserved areas. In a new radio (NR) system, the NTN, especially LEO or GEO, may have implicit compatibility to support both HAPS and air-to-ground (ATG) scenarios. It is agreed in release 17 (R17) that the NTN may focus on frequency division duplexing (FDD) while time division duplexing (TDD) may be applied for relevant scenarios, such as HAPS or ATG. In some events, the NTN may provide an earth fixed tracking area, and a user equipment (UE) in the NTN may have a GNSS capability.

In some events, the transmission in the NTN may be a transparent payload for the satellite. The NTN may be available for handheld devices in frequency range 1 (FR1), such as with a power class 3, and for very small aperture terminal (VSAT) devices with an external antenna at least in frequency range 2 (FR2). The NTN may provide an NTN cell with a wider coverage than a TN cell. Specifically, in NTN, the coverage of a cell or a beam is typically much larger than a cell in TN. For example, the coverage of an NTN cell may across multiple countries in some cases.

In R17, the mobility of the UE in a connected mode has been studied. In some events, legacy handover (HO) mechanisms may be supported with some restrictions: the UE is not required to connect to both an NTN cell and a TN cell simultaneously during a handover, and a dual active protocol stack (DAPS) is not supported.

In R17, additional CHO conditions are introduced for NTN specific CHO due to the NTN radio characteristics, i.e., the variation in signal strength or signal quality between cell-center and cell-edge is not so pronounced. The NTN specific CHO conditions may include a condEventT1 and condEventD1 for example, and condEventT1 and condEventD1 are always configured together with one of the measurement-based trigger conditions (CHO events A3/A4/A5). In some cases, the condEventD1 may be configured as a normal measurement event for measurement report.

In some events, for a candidate cell with condEventT1, the CHO recovery may not be executed if timer T2 has not expired. In some events, for a candidate cell with condEventD1, the CHO recovery can be excluded without checking condEventD1. Some of the conditions are listed in Table 1 below for reference.

TABLE 1

| NTN CHO | Description |
|---|---|
| condEventA4 | Measurement event A4 (i.e. Neighbor becomes better |
| | than threshold) |
| condEventT1 | Time-based trigger condition |
| | CHO can be executed only between T1 and T2 |
| | NW configures T1 (i.e. t1-Threshold) and duration |
| | (duration) using UTC time |
| condEventD1 | Location-based trigger condition |
| | CHO can be executed when the following two conditions |
| | are fulfilled |
| | Distance between UE and a referenceLocation1 > |
| | distanceThreshFromReference1; (away from PCell) |

In R18, the mobility and service continuity enhancements are further studied. For example, some agreements are shown in the text box below.

4.1.4 NTN-TN and NTN-NTN mobility and service continuity
enhancements
This work considers existing methods from NR TN as well as outcome of
Rel-17 NR NTN WI outcome as baseline for NTN-TN mobility.
Specify NTN-TN and NTN-NTN measurement/mobility and service
continuity enhancements [RAN2, RAN3, RAN4]
For NTN-NTN mobility, specify cell reselection enhancements for earth
moving cell, the timing based and location-based cell reselection for
quasi-earth fixed cell in Rel-17 can be considered as the starting
point. [RAN2, RAN3, RAN4]
Specify NTN-NTN handover enhancement for RRC_CONNECTED UEs
in the quasi-earth-fixed cell and earth-moving cell to reduce
the signalling overhead. [RAN2, RAN3]
Specify cell reselection enhancements for RRC_IDLE/INACTIVE UEs to
reduce UE power consumption (NTN-TN mobility is prioritized). [RAN2,
RAN3, RAN4]
Study and, if needed, specify enhancement to Xn[/NG] signalling to
support feeder link switch-over, CHO, e.g. exchange of necessary
information between gNBs. [RAN3]

During a deployment of NTN and TN, the characteristics of the NTN and the TN are considered, for example, the NTN can provide a wider coverage, but has a longer delay and lower throughput than the TN.

For a specific UE, when it is located within a serving cell, it may perform a handover to a candidate cell if a CHO condition is met. For example, the CHO condition may be based on a measurement event, such as A3, A4 or A5 event. However, the factor considered in the current handover solution is mainly a quality of the serving cell, which may insufficient for the handover. Thus, the handover mechanism is needed to be further studied and improved.

Example embodiments of the present disclosure provide a solution for switching between an NTN and a TN. Specifically, a UE may switch from a first cell to a second cell if a service based handover condition is met. As such, a service requirement may be considered while switching, and thus the service at the UE may be guaranteed. Principles and some example embodiments of the present disclosure will be described in detail below with reference to the accompanying drawings. In the present disclosure, the terms “handover”, “switching”, or “CHO” may be used interchangeable and the present disclosure does not limit this aspect.

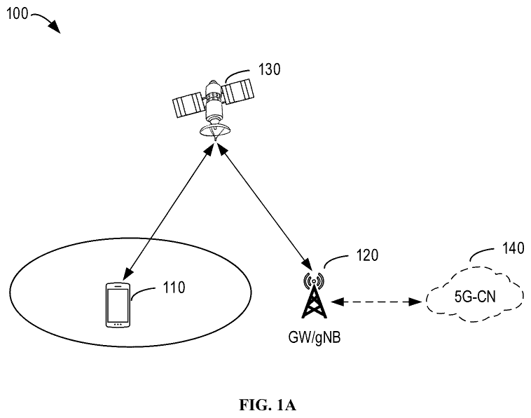

FIG. 1A illustrates an example network environment 100 in which some example embodiments of the present disclosure may be implemented. The network environment 100 may include a UE 110 and a satellite 130. As shown in FIG. 1A, the network environment 100 may include an NTN comprising the satellite 130 in communication with the UE 110. The device 120 shown in FIG. 1A may be a gateway (GW) device or a base station.

In some embodiments, the device 120 may be a BS 120 (such as a gNB). The satellite 130 may communicate with the UE 110 via a service link or a wireless interface, and the satellite 130 may communicate with the BS 120 via a feeder link or a wireless interface. In some embodiments, the satellite 130 may operate as a passive or transparent network relay node between the UE 110 and the BS 120. As shown in FIG. 1, the BS 120 may further communicate with a 5G core network (5G-CN) 140, for example via a gateway device. In some other embodiments, the device 120 may be a gateway device 120. The satellite 130 may operate as a further BS, such as another gNB. In some embodiments, the satellite 130 may communicate with the gateway device 120 associated with the 5G-CN 140.

Communications in the network environment 100 may be implemented according to any proper communication protocol(s), comprising, but not limited to, cellular communication protocols of the first generation (1G), the second generation (2G), the third generation (3G), the fourth generation (4G), the fifth generation (5G) and the sixth generation (6G) and the like, wireless local network communication protocols such as Institute for Electrical and Electronics Engineers (IEEE) 802.11 and the like, and/or any other protocols currently known or to be developed in the future. Moreover, the communication may utilize any proper wireless communication technology, comprising but not limited to: Code Division Multiple Access (CDMA), Frequency Division Multiple Access (FDMA), Time Division Multiple Access (TDMA), Frequency Division Duplex (FDD), Time Division Duplex (TDD), Multiple-Input Multiple-Output (MIMO), Orthogonal Frequency Division Multiple (OFDM), Discrete Fourier Transform spread OFDM (DFT-s-OFDM) and/or any other technologies currently known or to be developed in the future.

It is to be understood that the numbers of devices (i.e., the UE 110, the device (such as GW/gNB) 120 and the satellite 130) and their connection relationships and types shown in FIG. 1A are only for the purpose of illustration without suggesting any limitation. The environment 100 may include any suitable numbers of devices adapted for implementing embodiments of the present disclosure. It is to be understood that the network environment 100 shown in FIG. 1A is only for the purpose of illustration without suggesting any limitation as to the scope of the disclosure. For example, while FIG. 1A depicts the UE 110 as a mobile phone, the UE 110 may be any type of user equipment.

FIG. 1B illustrates an example network environment 105 in which some example embodiments of the present disclosure may be implemented. The network environment 105 may include a UE 110 and a satellite 130. As shown in FIG. 1B, the network environment 105 may include an NTN comprising the satellite 130 in communication with the UE 110, the NTN may also comprise a device 120, which may be a GW device or a gNB.

As shown in FIG. 1B, the UE 110 may located within an NTN cell 152. There may be multiple TN cells deployed within the coverage of the NTN cell 152, for example, there are TN cell 154, TN cell 156 and TN cell 158 shown in FIG. 1B. As an illustrated example, it is assumed that the TN cell 154 is associated with a beam #1, the TN cell 156 is associated with a beam #2, and the TN cell 158 is associated with a beam #3.

For ease of description, the TN cell 154 may be also be called as a TN-cell-1, the TN cell 156 may be also be called as a TN-cell-2, and the TN cell 158 may be also be called as a TN-cell-3. For the TN and NTN overlapped deployment scenario, the operators would like to use the TN and the NTN for different purposes. For an example, the NTN cell may be used to provide the coverage purpose. For another example, the service with high data rate or strict latency requirement is provided through the TN cell. For a further another example, the service with low data rate and relaxed latency requirement is provided through the NTN cell.

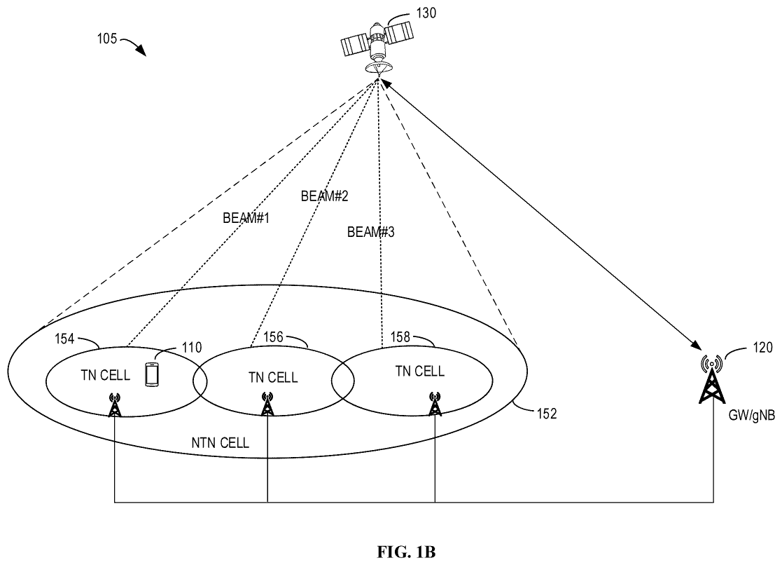

FIG. 2 illustrates an example of a process flow 200 in accordance with some example embodiments of the present disclosure. The process flow 200 involves a UE 201 and a BS 202. With reference to FIGS. 1A-1B, the UE 201 may be the UE 110, the BS 202 may be the BS 120 (when the satellite 130 operates as a transparent relay node) or the satellite 130 (when the satellite 130 operates as a gNB). It would be appreciated that although the process flow 200 may be likewise applied to other communication scenarios.

In the process flow 200, the UE 201 determines 210 whether a service based handover condition is met. In some embodiments, the UE 201 is in a connected mode, and is in a serving cell provided by the BS 202. In some examples, the UE 201 may enter into a radio resource control (RRC) connected mode by a RRC connection procedure. For example, the serving cell may be an NTN cell, such as the NTN cell 152 shown in FIG. 1B. It is to be understood that the serving cell may also be a TN cell, such as the TN cell 154 shown in FIG. 1B, the present disclosure does not limit this aspect.

In some example embodiments, the service based handover condition may also be called as a service specific handover condition. In some example embodiments, the service based handover condition may be associated with quality of service (QoS) requirements. In some example embodiments, the service based handover condition may associated with one or more of: a service type, a latency requirement of the service, a data rate of the service, a data amount of the service, or a time length that data buffered in the UE pending for transmission.

In the process flow 200, the UE 201 switches 220 from a first cell to a second cell if the service based handover condition is met. In some example embodiments, the first cell may be an NTN cell and the second cell may be a TN cell. The service based handover condition may indicate one or more of: a service type of the UE is associated with a specific 5QI, a latency requirement of a service of the UE is below than a threshold of latency, a data rate of the service is higher than a threshold of rate, a data amount of the service is higher than a threshold of amount, or a time length that data buffered in the UE pending for transmission is higher than a threshold of time. For example, the specific 5QI may correspond to specific QoS requirements. For example, the threshold of latency may be denoted as X ms, the threshold of rate may be denoted as Y bytes, the threshold of amount may be denoted as A bytes, and the threshold of time may be denoted as B ms.

In some other example embodiments, the first cell may be a TN cell, and the second cell may be an NTN cell. The service based handover condition may indicate one or more of: a service type of the UE is not associated with a specific 5QI, a latency requirement of a service of the UE is higher than a threshold of latency, a data rate of the service is below than a threshold of rate, a data amount of the service is below than a threshold of amount, or a time length that data buffered in the UE pending for transmission is below than a threshold of time.

In some embodiments, the service based handover condition may be indicated by the BS 202. Alternatively or in addition, as shown in FIG. 2, the BS 202 may determine the service based handover condition for the UE 201, and transmit 2031 the service based handover condition 2032 to the UE 201. On the other side of communication, the UE 201 may receive 2033 the service based handover condition 2032. As such, the service based handover condition 2032 may be configured by the BS 202.

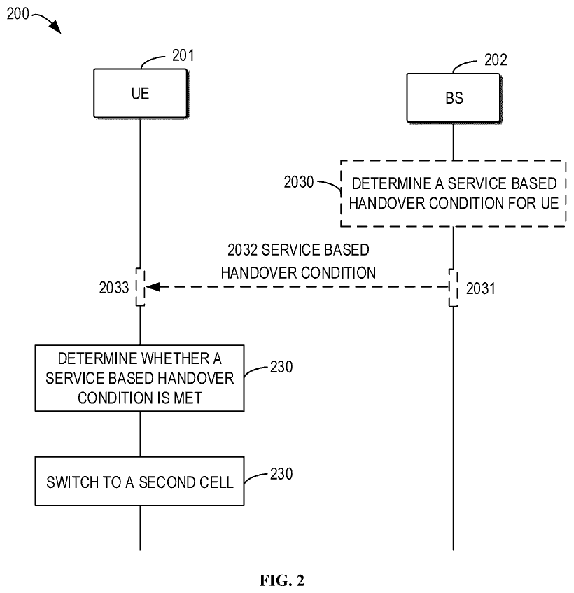

In some examples, the service based handover condition 2032 may be associated with the second cell. For example, the service based handover condition 2032 may be designed for the specific second cell. For example, different candidate cells may have different service based handover conditions. Such example embodiments will be further detailed below with reference to FIG. 3.

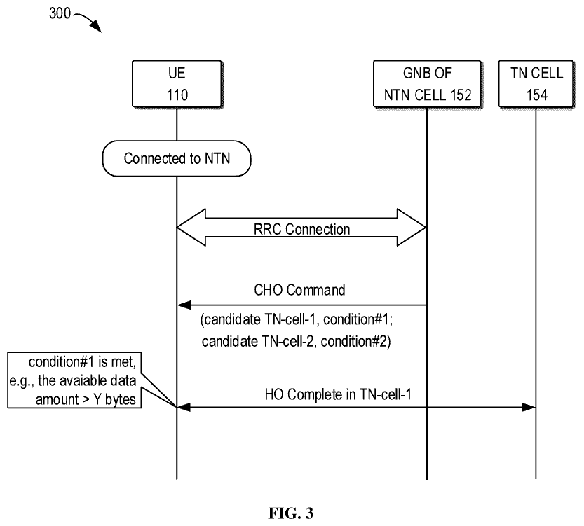

In some examples, the service based handover condition 2032 may be associated with multiple cells. For example, the multiple cells may include all (or some) candidate cells. For example, the multiple cells include the second cell. In some embodiments, the UE 201 may choose which cell to be as the second cell when the service based handover condition 2032 is met. In some examples, the BS 202 may transmit multiple cell level conditions associated with the multiple cells. Accordingly, the UE 201 may receive the multiple cell level conditions and may determine the second cell based on cell level conditions of the multiple cells. In some examples, the service based handover condition 2032 and the multiple cell level conditions may be carried in a same signal or may be in different signals. Such example embodiments will be further detailed below with reference to FIG. 4.

In some embodiments, the UE 201 may determine the second cell on its own. In some examples, when the service based handover condition is met, the UE 201 may select one candidate cell as the target cell (i.e., the second cell). In some examples, the BS 202 may transmit the service based handover condition to the UE 201, and the service based handover condition may be used as a target cell select condition, in other words, the UE 201 initiates selecting the target cell if the service based handover condition is met.

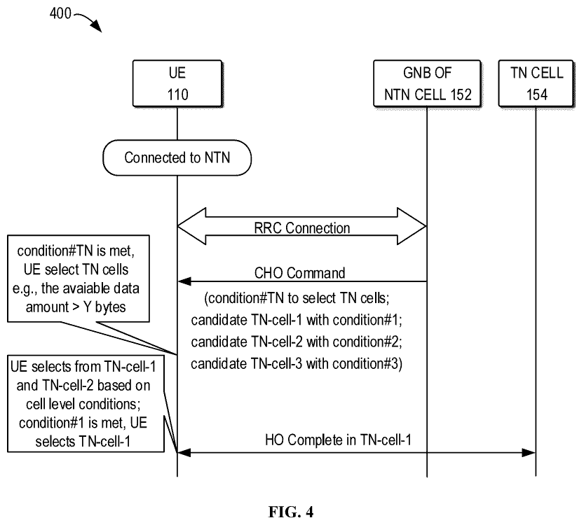

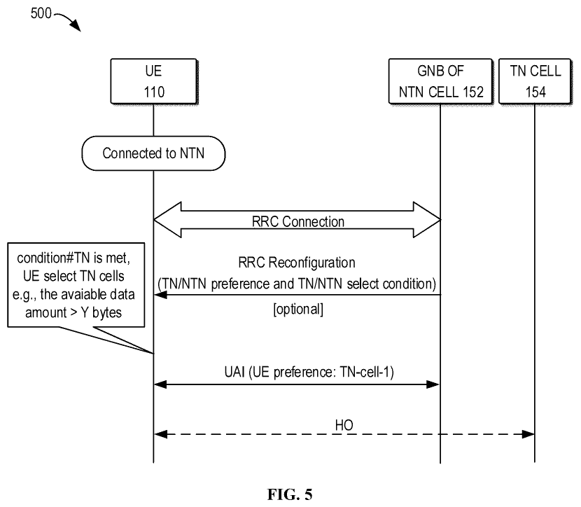

In some examples, the UE 201 may transmit an indication of the second cell to the BS 202. On the other side of communication, the BS 202 may receive the indication of the second cell, so that the BS 202 may be aware of the target cell. In some examples, the UE 201 may transmit user assistance information (UAI) indicating UE preference of the second cell. As such, the BS 202 may be aware of that the UE 201 would perform a handover to the second cell. Such example embodiments will be further detailed below with reference to FIG. 5. In some examples, after selecting the second cell as the target cell, the UE 201 may drop the first cell, and switch to the second cell to trigger an RRC reestablishment procedure. Such example embodiments will be further detailed below with reference to FIG. 6.

Based on the embodiments with reference to FIG. 2, the UE 201 may switch from a first cell to a second cell if a service based handover condition is met. As such, a service requirement may be considered while switching, and thus the service at the UE may be guaranteed.

FIG. 3 illustrates an example of a process flow 300 for the BS configuring the service based handover condition associated with one cell in accordance with some example embodiments of the present disclosure. For the purpose of discussion, the example process 300 will be described with reference to FIG. 1B.

In the process flow 300, the UE 110 may connect to an NTN. For example, the UE 110 may enter to an RRC connected state through an RRC connection procedure with the gNB of the NTN cell 152, for example, the gNB of the NTN cell 152 may be the satellite 130. The gNB of the NTN cell 152 may transmit a CHO command to the UE 110. The CHO command includes a condition #1 associated with a candidate TN-cell-1 and a condition #2 associated with a candidate TN-cell-2. It is to be understood that both the condition #1 and the condition #2 are service based handover conditions. By referring to FIG. 1B, it is assumed that TN-cell-1 is the TN cell 154 and TN-cell-2 is the TN cell 156. For example, the condition #1 may indicate that the available data amount is higher than Y bytes.

Continuing with reference to FIG. 3, the UE 110 may determine that the condition #1 is met, and the UE 110 may perform a switch to TN-cell-1 (i.e., TN cell 154 in FIG. 1B) which is associated with condition #1. The UE 110 may connect to TN cell 154 if the HO is completed.

FIG. 4 illustrates an example of a process flow 400 for the BS configuring the service based handover condition associated with multiple cells in accordance with some example embodiments of the present disclosure. For the purpose of discussion, the example process 400 will be described with reference to FIG. 1B.

In the process flow 400, the UE 110 may connect to an NTN. For example, the UE 110 may enter to an RRC connected state through an RRC connection procedure with the gNB of the NTN cell 152, for example, the gNB of the NTN cell 152 may be the satellite 130. The gNB of the NTN cell 152 may transmit a CHO command to the UE 110. The CHO command includes a condition #TN which is used for the UE 110 to trigger selecting the target TN cell. In some examples, the condition #TN may associate with TN-cell-1 (i.e., TN cell 154 in FIG. 1B) and TN-cell-2 (i.e., TN cell 156 in FIG. 1B). For example, the condition #TN may indicate that the available data amount is higher than Y bytes. Alternatively or in addition, the CHO command may also include cell level conditions: a condition #1 associated with a candidate TN-cell-1, a condition #2 associated with a candidate TN-cell-2, and a condition #3 associated with a candidate TN-cell-3.

Continuing with reference to FIG. 4, the UE 110 may determine that the condition #TN is met, since the condition #TN is associated with both TN-cell-1 and TN-cell-2, the UE 110 may further choose one as the target cell, from TN-cell-1 and TN-cell-2.

Specifically, the UE 110 may choose the target cell based on cell level conditions. In some examples, if the condition #1 is met, the target cell is the TN-cell-1 (i.e., TN cell 154 in FIG. 1B). The UE 110 may perform a switch to TN-cell-1 (i.e., TN cell 154 in FIG. 1B) which is associated with condition #1. The UE 110 may connect to TN-cell-1 154 if the HO is completed.

FIG. 5 illustrates an example of a process flow 500 for UE preference in accordance with some example embodiments of the present disclosure. For the purpose of discussion, the example process 500 will be described with reference to FIG. 1B.

In the process flow 500, the UE 110 may connect to an NTN. For example, the UE 110 may enter to an RRC connected state through an RRC connection procedure with the gNB of the NTN cell 152, for example, the gNB of the NTN cell 152 may be the satellite 130.

Alternatively or in addition, as shown in FIG. 5, an RRC reconfiguration procedure may be performed between the UE 110 and the gNB of the NTN cell 152. In some examples, the RRC reconfiguration may indicate TN/NTN preference and/or TN/NTN select condition(s). In some examples, the TN preference may indicate that the gNB of the NTN cell 152 suggests the TN-cell-1 to be a target TN cell. In some examples, the TN select condition may be the condition #TN which has been described above with reference to FIG. 4. For example, the condition #TN may indicate that the available data amount is higher than Y bytes.

Continuing with reference to FIG. 5, the UE 110 may determine that the TN select condition (such as condition #TN) is met, and the UE 110 may select a TN cell to be as a target TN cell, for example, the UE 110 may choose TN-cell-1 as the target TN cell. In some examples, the UE 110 may transmit UAI to the gNB of the NTN cell 152 to indicate the UE preference, for example, the UE preference may indicate that the UE prefers the TN-cell-1 as the target TN cell.

FIG. 6 illustrates an example of a process flow 600 for UE decision in accordance with some example embodiments of the present disclosure. For the purpose of discussion, the example process 600 will be described with reference to FIG. 1B.

In the process flow 600, the UE 110 may connect to an NTN. For example, the UE 110 may enter to an RRC connected state through an RRC connection procedure with the gNB of the NTN cell 152, for example, the gNB of the NTN cell 152 may be the satellite 130.

In the process flow 600, an RRC reconfiguration procedure may be performed between the UE 110 and the gNB of the NTN cell 152. In some examples, the RRC reconfiguration may indicate TN/NTN select condition(s). In some examples, the TN select condition may be the condition #TN which has been described above with reference to FIG. 4. For example, the condition #TN may indicate that the available data amount is higher than Y bytes.

Continuing with reference to FIG. 6, the UE 110 may determine that the TN select condition (such as condition #TN) is met, and the UE 110 may select a TN cell to be as a target TN cell, for example, the UE 110 may choose TN-cell-1 as the target TN cell. Additionally, the UE 110 may drop the NTN cell and perform an RRC reestablishment with the TN-cell-1 154. It is to be understood that the cause of the RRC reestablishment may be switch from the NTN due to service, as described in detail above.

As such, the handover may be performed based on service requirements, thus the service at the UE may be guaranteed. For a specific example, when the UE 110 has a connection with the NTN cell 152 and has an enhanced mobile broadband (eMBB) service, since the UE's data throughput is increased and the NTN cell 152 cannot offer more data rate to the UE 110, the UE 110 may switch to the TN cell 154. As such, there is no need for the UE 110 to endure the low data rate in the NTN cell 152 until receiving an NTN HO command from the NTN cell 152. Thus, the data transmission efficiency may be improved at the UE.

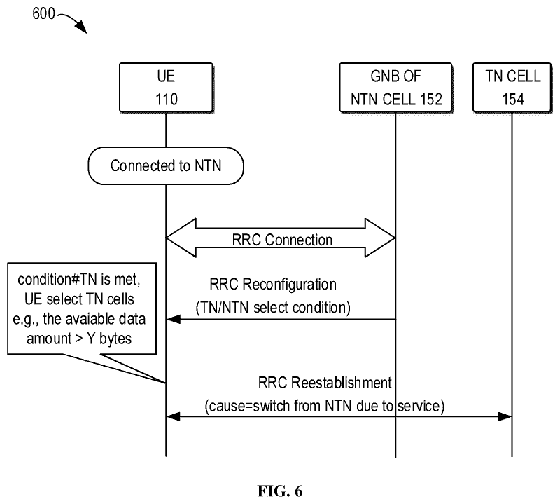

FIG. 7 illustrates a flowchart of a method 700 implemented at a UE in accordance with some example embodiments of the present disclosure. For the purpose of discussion, the method 700 will be described from the perspective of the UE 110/201.

At block 710, the UE 110/201 determines whether a service based handover condition is met. At block 720, the UE 110/201 switches from a first cell to a second cell if the service based handover condition is met, where the first cell is one of an NTN cell and a TN cell, the second cell is the other of the NTN cell and the TN cell.

In some example embodiments, the UE 110/201 receives, from a BS, information indicating the service based handover condition associated with the second cell. In some example embodiments, the UE 110/201 receives, from a BS, information indicating the service based handover condition associated with multiple cells comprising the second cell and a cell level condition associated with the second cell. And the UE 110/201 determines the second cell based on the cell level condition.

In some example embodiments, the UE 110/201 determines the second cell on its own, and transmits an indication of the second cell selected by the UE. In some example embodiments, the UE 110/201 drops the first cell, and performs an RRC re-establishment with the second cell, where the second cell is determined by the UE 110/201.

In some example embodiments, the first cell is the NTN cell and the second cell is the TN cell, and wherein the service based handover condition indicates at least one of: a service type of the UE is associated with a specific 5QI, a latency requirement of a service of the UE is below than a threshold of latency, a data rate of the service is higher than a threshold of rate, a data amount of the service is higher than a threshold of amount, or a time length that data buffered in the UE pending for transmission is higher than a threshold of time.

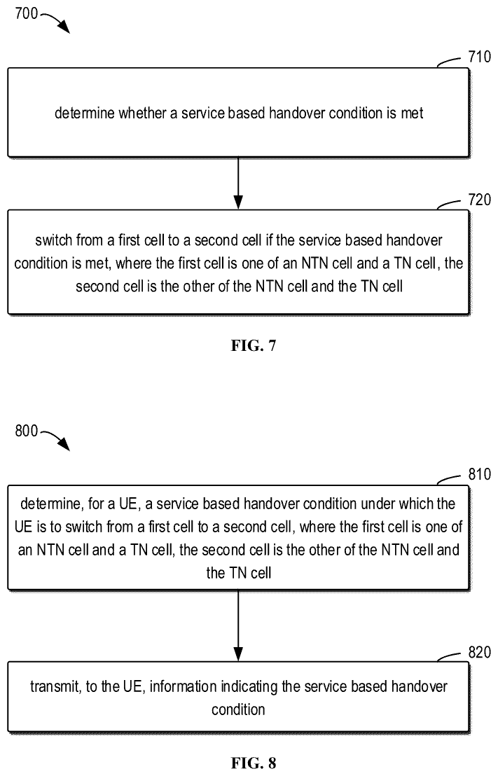

FIG. 8 illustrates a flowchart of a method 800 implemented at a BS in accordance with some example embodiments of the present disclosure. For the purpose of discussion, the method 800 will be described from the perspective of the BS 202.

At block 810, the BS 202 determines, for a UE, a service based handover condition under which the UE is to switch from a first cell to a second cell, where the first cell is one of an NTN cell and a TN cell, the second cell is the other of the NTN cell and the TN cell. At block 820, the BS 202 transmits, to the UE, information indicating the service based handover condition.

In some example embodiments, the information indicates that the service based handover condition is associated with the second cell. In some example embodiments, the information indicates: the service based handover condition is associated with multiple cells comprising the second cell, and a cell level condition associated with the second cell. In some example embodiments, the BS 202 receives, from the UE, an indication of the second cell determined by the UE.

In some example embodiments, the first cell is the NTN cell and the second cell is the TN cell, and wherein the service based handover condition indicates at least one of: a service type of the UE is associated with a specific 5QI, a latency requirement of a service of the UE is below than a threshold of latency, a data rate of the service is higher than a threshold of rate, a data amount of the service is higher than a threshold of amount, or a time length that data buffered in the UE pending for transmission is higher than a threshold of time.

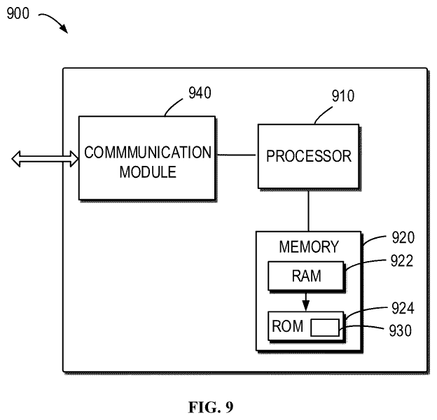

FIG. 9 illustrates a simplified block diagram of a device 900 that is suitable for implementing some example embodiments of the present disclosure. The device 900 may be provided to implement the communication device, for example the UE 110/201, or the BS 202. As shown, the device 900 includes a processor 910, a memory 920 coupled to the processor 910, and a transceiver 940 coupled to the processor 910.

The transceiver 940 is for bidirectional communications. The transceiver 940 is coupled to at least one antenna to facilitate communication. The transceiver 940 can comprise a transmitter circuitry (e.g., associated with one or more transmit chains) and/or a receiver circuitry (e.g., associated with one or more receive chains). The transmitter circuitry and receiver circuitry can employ common circuit elements, distinct circuit elements, or a combination thereof.

The processor 910 may be of any type suitable to the local technical network and may include one or more of the following: general purpose computers, special purpose computers, microprocessors, digital signal processors (DSPs) and processors based on multicore processor architecture, as non-limiting examples. The device 900 may have multiple processors, such as an application specific integrated circuit chip that is slaved in time to a clock which synchronizes the main processor.

The memory 920 may include one or more non-volatile memories and one or more volatile memories. Examples of the non-volatile memories include, but are not limited to, a Read Only Memory (ROM) 924, an electrically programmable read only memory (EPROM), a flash memory, a hard disk, a compact disc (CD), a digital video disk (DVD), and other magnetic storage and/or optical storage. Examples of the volatile memories include, but are not limited to, a random access memory (RAM) 922 and other volatile memories that will not last in the power-down duration.

A computer program 930 includes computer executable instructions that are executed by the associated processor 910. The program 930 may be stored in the ROM 924. The processor 910 may perform any suitable actions and processing by loading the program 930 into the RAM 922.

The embodiments of the present disclosure may be implemented by means of the program 930 so that the device 900 may perform any process of the disclosure as discussed with reference to FIGS. 2-6. The embodiments of the present disclosure may also be implemented by hardware or by a combination of software and hardware.

The present disclosure also provides at least one computer program product tangibly stored on a non-transitory computer readable storage medium. The computer program product includes computer-executable instructions, such as those included in program modules, being executed in a device on a target real or virtual processor, to carry out the method 700 as described above with reference to FIG. 7 and/or the method 800 as described above with reference to FIG. 8.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1. A baseband processor of a user equipment (UE) configured to perform operations comprising:
determining whether a service based handover condition is met; and
in accordance with a determination that the service based handover condition is met, switching from a first cell to a second cell, the first cell being one of a non-terrestrial network (NTN) cell and a terrestrial network (TN) cell, the second cell being the other of the NTN cell and the TN cell.

2. The processor of the UE of claim 1, wherein the processor is further configured to perform operations comprising:
receiving, using a transceiver and from a base station (BS), information indicating the service based handover condition associated with the second cell.

3. The processor of the UE of claim 1, wherein the processor is further configured to perform operations comprising:
receiving, using the transceiver and from a BS, information indicating the service based handover condition associated with multiple cells comprising the second cell and a cell level condition associated with the second cell; and
determining the second cell based on the cell level condition.

4. The processor of the UE of claim 1, wherein the processor is further configured to perform operations comprising:
transmitting, using a transceiver and to the BS, an indication of the second cell determined by the UE.

5. The processor of the UE of claim 1, wherein the processor is configured to perform switching by:
dropping the first cell; and
performing a radio resource control (RRC) re-establishment with the second cell.

6. The processor of the UE of claim 1, wherein the first cell is the NTN cell and the second cell is the TN cell, and wherein the service based handover condition indicates at least one of:
a service type of the UE is associated with a specific 5QI,
a latency requirement of a service of the UE is below than a threshold of latency,
a data rate of the service is higher than a threshold of rate,
a data amount of the service is higher than a threshold of amount, or
a time length that data buffered in the UE pending for transmission is higher than a threshold of time.

7. A baseband processor of a base station (BS) configured to perform operations comprising:
determining, for a user equipment (UE), a service based handover condition under which the UE is to switch from a first cell to a second cell, the first cell being one of a non-terrestrial network (NTN) cell and a terrestrial network (TN) cell, the second cell being the other of the NTN cell and the TN cell; and
transmitting, using a transceiver and to the UE, information indicating the service based handover condition.

8. The processor of the BS of claim 7, wherein the information indicates that the service based handover condition is associated with the second cell.

9. The processor of the BS of claim 7, wherein the information indicates:
the service based handover condition is associated with multiple cells comprising the second cell, and
a cell level condition associated with the second cell.

10. The processor of the BS of claim 7, wherein the processor is further configured to perform operations comprising:
receiving, using the transceiver and from the UE, an indication of the second cell determined by the UE.

11. The processor of the BS of claim 7, wherein the first cell is the NTN cell and the second cell is the TN cell, and wherein the service based handover condition indicates at least one of:
a service type of the UE is associated with a specific 5QI,
a latency requirement of a service of the UE is below than a threshold of latency,
a data rate of the service is higher than a threshold of rate,
a data amount of the service is higher than a threshold of amount, or
a time length that data buffered in the UE pending for transmission is higher than a threshold of time.

12. A user equipment (UE) comprising:
a transceiver configured to communicate with a network; and
a processor communicatively coupled to the transceiver and configured to perform operations comprising:
determining whether a service based handover condition is met; and
in accordance with a determination that the service based handover condition is met, switching from a first cell to a second cell, the first cell being one of a non-terrestrial network (NTN) cell and a terrestrial network (TN) cell, the second cell being the other of the NTN cell and the TN cell.

13. The UE of claim 12, wherein the processor is further configured to perform operations comprising:
receiving, using the transceiver and from a base station (BS), information indicating the service based handover condition associated with the second cell.

14. The UE of claim 12, wherein the processor is further configured to perform operations comprising:
receiving, using the transceiver and from a BS, information indicating the service based handover condition associated with multiple cells comprising the second cell and a cell level condition associated with the second cell; and
determining the second cell based on the cell level condition.

15. The UE of claim 12, wherein the processor is further configured to perform operations comprising:
transmitting, using the transceiver and to the BS, an indication of the second cell determined by the UE.

16. The UE of claim 12, wherein the processor is configured to perform switching by:
dropping the first cell; and
performing a radio resource control (RRC) re-establishment with the second cell.

17. The UE of claim 12, wherein the first cell is the NTN cell and the second cell is the TN cell, and wherein the service based handover condition indicates at least one of:
a service type of the UE is associated with a specific 5QI,
a latency requirement of a service of the UE is below than a threshold of latency,
a data rate of the service is higher than a threshold of rate,
a data amount of the service is higher than a threshold of amount, or
a time length that data buffered in the UE pending for transmission is higher than a threshold of time.

18-22. (canceled)
